(19) United States
(12) Patent Application Publication
(10) Pub. No.: US 2019/0222358 A1
(43) Pub. Date: Jul. 18, 2019

(54) NETWORK NODE, USER DEVICE, AND METHOD FOR WIRELESS COMMUNICATION SYSTEM

(71) Applicant: GUANGDONG OPPO MOBILE TELECOMMUNICATION CORP., LTD., Dongguan, Guangdong (CN)

(72) Inventor: Hua XU, Ottawa (CA)

(73) Assignee: GUANGDONG OPPO MOBILE TELECOMMUNICATION CORP., LTD., Dongguan, Guangdong (CN)

(21) Appl. No.: 16/336,372

(22) PCT Filed: Feb. 7, 2018
(86) PCT No.: PCT/CN2018/075639

§ 371 Date: Mar. 25, 2019

Related U.S. Application Data
(60) Provisional application No. 62/466,077, filed on Mar. 2, 2017.
(60) Provisional application No. 62/500,146, filed on May 2, 2017.

(51) Int. Cl. H04L 1/16; H04L 5/00; H04W 72/04

(52) U.S. Cl. CPC H04L 1/1614; H04L 5/0007; H04W 72/042; H04L 5/0058

(57) ABSTRACT

A network node, a user device, and a method for a wireless communication system are provided. The network node includes a processor and a transceiver. The processor is configured to allocate a plurality of control channel elements (CCEs) for a physical downlink control channel (PDCCH) having PDCCH candidates defined for a plurality of different CCE aggregation levels (ALs). The processor is configured to form at least one search space block containing the CCEs of different CCE ALs, the at least one search space block is in a nested structure to carry PDCCH candidates with the different CCE ALs, and the processor is configured to determine start positions of the at least one search space block. The processor is configured to determine locations of the PDCCH candidates of the different CCE ALs within the at least one search space block.

### BACKGROUND OF THE DISCLOSURE

### 1. Field of the Disclosure

The present disclosure relates to the field of communication systems, and more particularly, to a network node, a user device, and a method for a wireless communication system.

### 2. Description of the Related Art

In long term evolution (LTE), a physical channel of the LTE can be classified into a downlink channel, i.e., a physical downlink shared channel (PDSCH) and a physical downlink control channel (PDCCH), and an uplink channel, i.e., a physical uplink shared channel (PUSCH) and a physical uplink control channel (PUCCH).

The PDCCH is used to transfer downlink control information that informs a user device about resource allocations or scheduling related to downlink resource assignments on the PDSCH, uplink resource grants, and uplink power control commands.

PDCCH signal is designed to be demodulated at the user device based on a cell specific reference signal (CRS). However, use of the CRS does not take into account of increased complexities of the LTE systems. The use of the cell specific reference signal can limit advanced techniques to increase cell capacity.

### SUMMARY

An object of the present disclosure is to propose a network node, a user device, and a method for a wireless communication system to balance between channel estimation performance.

In a first aspect of the present disclosure, a network node for a wireless communication system includes a processor and a transceiver. The processor is configured to allocate a plurality of control channel elements (CCEs) for a physical downlink control channel (PDCCH) having PDCCH candidates defined for a plurality of different CCE aggregation levels (ALs). A number of CCEs is defined by the different CCE ALs. The CCEs are allocated to a user device. The processor is configured to form at least one search space block containing the CCEs of different CCE ALs, the at least one search space block is in a nested structure to carry PDCCH candidates with the different CCE ALs. The transceiver is configured to transmit the PDCCH on allocated CCEs in the at least one search space block to the user device.

According to an embodiment in conjunction with the first aspect of the present disclosure, the processor is configured to determine start positions of the at least one search space block and the processor is configured to determine locations of the PDCCH candidates of the different CCE ALs within the at least one search space block.

According to an embodiment in conjunction with the first aspect of the present disclosure, the processor is configured to determine start positions of the PDCCH candidates within the at least one search space block based on at least one of an output of a first hashing function, a first offset, and a bit-map.

According to an embodiment in conjunction with the first aspect of the present disclosure, the inputs of the first hashing function include at least one of the identity of the user device and a slot/symbol index.

According to an embodiment in conjunction with the first aspect of the present disclosure, the first hashing function is used in conjunction with a second offset.

According to an embodiment in conjunction with the first aspect of the present disclosure, the processor is configured to determine the start positions of the at least one search space block using at least one of an output of a second hashing function, a third offset, and a bit-map configuration to the user device.

According to an embodiment in conjunction with the first aspect of the present disclosure, the processor is configured to shift the start positions of the at least one search space block by an offset.

According to an embodiment in conjunction with the first aspect of the present disclosure, the search space blocks are located contiguously over time of a control region.

According to an embodiment in conjunction with the first aspect of the present disclosure, the search space blocks are located contiguously over frequency of a control region.

According to an embodiment in conjunction with the first aspect of the present disclosure, the search space blocks are distributed over time of a control region.

According to an embodiment in conjunction with the first aspect of the present disclosure, the search space blocks are distributed over frequency of a control region.

According to an embodiment in conjunction with the first aspect of the present disclosure, the search space blocks have different sizes.

According to an embodiment in conjunction with the first aspect of the present disclosure, a number of PDCCH candidates of each CCE AL in a search space blocks are configured.

According to an embodiment in conjunction with the first aspect of the present disclosure, the processor is configured to map the CCEs of the PDCCH candidates onto frequency in a distributed manner.

According to an embodiment in conjunction with the first aspect of the present disclosure, the processor is configured to map the CCEs of the PDCCH candidates onto time in a contiguous manner.

According to an embodiment in conjunction with the first aspect of the present disclosure, the CCEs include a plurality of resource element groups (REGs), wherein the CCE is a mapping unit of the PDCCH candidates, and the processor is configured to map the REGs on contiguous resources.

In a second aspect of the present disclosure, a user device for a wireless communication system includes a processor and a transceiver. The processor is configured to determine a plurality of control channel elements (CCEs) for at least one network node. The transceiver is configured to transmit the CCEs in a physical downlink control channel (PDCCH) to the at least one network node. The CCEs are allocated for the PDCCH having PDCCH candidates defined for a plurality of different CCE aggregation levels (ALs). A number of CCEs is defined by the different CCE ALs. The CCEs are associated with a user device. The processor is configured to form at least one search space block containing the CCEs of different CCE ALs. The at least one search space block is in a nested structure to carry PDCCH candidates with the different CCE ALs.

According to another embodiment in conjunction with the second aspect of the present disclosure, the processor is configured to determine start positions of the at least one search space block, and the processor is configured to determine locations of the PDCCH candidates of the different CCE ALs within the at least one search space block.

According to another embodiment in conjunction with the second aspect of the present disclosure, the processor is configured to determine start positions of the PDCCH candidates within the at least one search space block based on at least one of an output of a first hashing function, a first offset, and a bit-map.

According to another embodiment in conjunction with the second aspect of the present disclosure, the at least one search space block based on at least one of an output of a first hashing function, a first offset, and a bit-map.

According to another embodiment in conjunction with the second aspect of the present disclosure, the inputs of the first hashing function include at least one of the identity of the user device and a slot/symbol index.

According to another embodiment in conjunction with the second aspect of the present disclosure, the first hashing function is used in conjunction with a second offset.

According to another embodiment in conjunction with the second aspect of the present disclosure, the processor is configured to determine the start positions of the at least one search space block using at least one of an output of a second hashing function, a third offset, and a bit-map configuration to the user device.

According to another embodiment in conjunction with the second aspect of the present disclosure, the processor is configured to shift the start positions of the at least one search space block by an offset.

According to another embodiment in conjunction with the second aspect of the present disclosure, the search space blocks are located contiguously over time of a control region.

According to another embodiment in conjunction with the second aspect of the present disclosure, the search space blocks are located contiguously over frequency of a control region.

According to another embodiment in conjunction with the second aspect of the present disclosure, the search space blocks are distributed over time of a control region.

According to another embodiment in conjunction with the second aspect of the present disclosure, the search space blocks are distributed over frequency of a control region.

According to another embodiment in conjunction with the second aspect of the present disclosure, the search space blocks have different sizes.

According to another embodiment in conjunction with the second aspect of the present disclosure, a number of PDCCH candidates of each CCE AL in a search space blocks are configured.

According to another embodiment in conjunction with the second aspect of the present disclosure, the processor is configured to map the CCEs of the PDCCH candidates onto frequency in a distributed manner.

According to another embodiment in conjunction with the second aspect of the present disclosure, the processor is configured to map the CCEs of the PDCCH candidates onto time in a contiguous manner.

According to another embodiment in conjunction with the second aspect of the present disclosure, the CCEs include a plurality of resource element groups (REGs), wherein the CCE is a mapping unit of the PDCCH candidates, and the processor is configured to map the REGs on contiguous resources.

In a third aspect of the present disclosure, a method for a wireless communication system includes allocating a plurality of control channel elements (CCEs) on a physical downlink control channel (PDCCH) having PDCCH candidates defined for a plurality of different CCE aggregation levels (ALs) and transmitting the PDCCH on allocated CCEs in the at least one search space block to the user device. A number of CCEs is defined by the different CCE ALs. The CCEs are allocated to a user device. The method further includes forming at least one search space block containing the CCEs of different CCE ALs. The at least one search space block is in a nested structure to carry PDCCH candidates with the different CCE ALs.

According to another embodiment in conjunction with the third aspect of the present disclosure, the method further includes determining start positions of the at least one search space block and determining locations of the PDCCH candidates of the different CCE ALs within the at least one search space block.

According to another embodiment in conjunction with the third aspect of the present disclosure, the method further includes determining start positions of the PDCCH candidates within the at least one search space block based on at least one of an output of the a first hashing function, a first offset, and a bit-map.

According to another embodiment in conjunction with the third aspect of the present disclosure, the inputs of the first hashing function include at least one of the identity of the user device and a slot/symbol index.

According to another embodiment in conjunction with the third aspect of the present disclosure, the first hashing function is used in conjunction with a second offset.

According to another embodiment in conjunction with the third aspect of the present disclosure, the method further includes determining the start positions of the at least one search space block using at least one of an output of a second hashing function, a third offset, and a bit-map configuration to the user device.

According to another embodiment in conjunction with the third aspect of the present disclosure, the method further includes shifting the start positions of the at least one search space block by an offset.

According to another embodiment in conjunction with the third aspect of the present disclosure, the search space blocks are located contiguously over time of a control region.

According to another embodiment in conjunction with the third aspect of the present disclosure, the search space blocks are located contiguously over frequency of a control region.

According to another embodiment in conjunction with the third aspect of the present disclosure, the search space blocks are distributed over time of a control region.

According to another embodiment in conjunction with the third aspect of the present disclosure, the search space blocks are distributed over frequency of a control region.

According to another embodiment in conjunction with the third aspect of the present disclosure, the search space blocks have different sizes.

According to another embodiment in conjunction with the third aspect of the present disclosure, a number of PDCCH candidates of each CCE AL in a search space blocks are configured.

According to another embodiment in conjunction with the third aspect of the present disclosure, the method further includes mapping the CCEs of the PDCCH candidates onto frequency in a distributed manner.

According to another embodiment in conjunction with the third aspect of the present disclosure, the method further includes mapping the CCEs of the PDCCH candidates onto time in a contiguous manner.

According to another embodiment in conjunction with the third aspect of the present disclosure, the CCEs include a plurality of resource element groups (REGs), the CCE is a mapping unit of the PDCCH candidates, and wherein the method further includes mapping the REGs on contiguous resources.

In the embodiment of the present disclosure, the processor is configured to group the CCEs in a search space into at least one search space block based on the different CCE ALs. The at least one search space block is in a nested structure to carry PDCCH candidates with the different CCE ALs. The processor is configured to determine start positions of the at least one search space block to balance between channel estimation performance.

### BRIEF DESCRIPTION OF THE DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of a network node for a wireless communication system according to an embodiment of the present disclosure.

FIG. 2 is a flowchart illustrating a method for a wireless communication system according to an embodiment of the present disclosure.

FIG. 3 is a block diagram of a user device for a wireless communication system according to an embodiment of the present disclosure.

FIG. 4 is a diagram of mapping of control channel elements (CCEs) in a distributed manner on the same orthogonal frequency-division multiplexing (OFDM) symbol according to an embodiment of the present disclosure.

FIG. 5 is a diagram of mapping of CCEs in a distributed manner on different OFDM symbols according to an embodiment of the present disclosure.

FIG. 6 is a diagram of physical downlink control channel (PDCCH) candidates according to an embodiment of the present disclosure.

FIG. 7 is a diagram of search space blocks according to an embodiment of the present disclosure.

FIG. 8 is a diagram of a search space according to an embodiment of the present disclosure.

FIG. 9 is a diagram of a search space according to an embodiment of the present disclosure.

FIG. 10 is a diagram of a search space according to an embodiment of the present disclosure.

FIG. 11 is a diagram of a search space according to an embodiment of the present disclosure.

FIG. 12 is a diagram of a search space according to an embodiment of the present disclosure.

FIG. 13 is a diagram of a search space according to an embodiment of the present disclosure.

FIG. 14 is a diagram of a search space according to an embodiment of the present disclosure.

FIG. 15 is a diagram of a search space according to an embodiment of the present disclosure.

FIG. 16 is a diagram of a search space according to an embodiment of the present disclosure.

### DETAILED DESCRIPTION OF THE EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the invention.

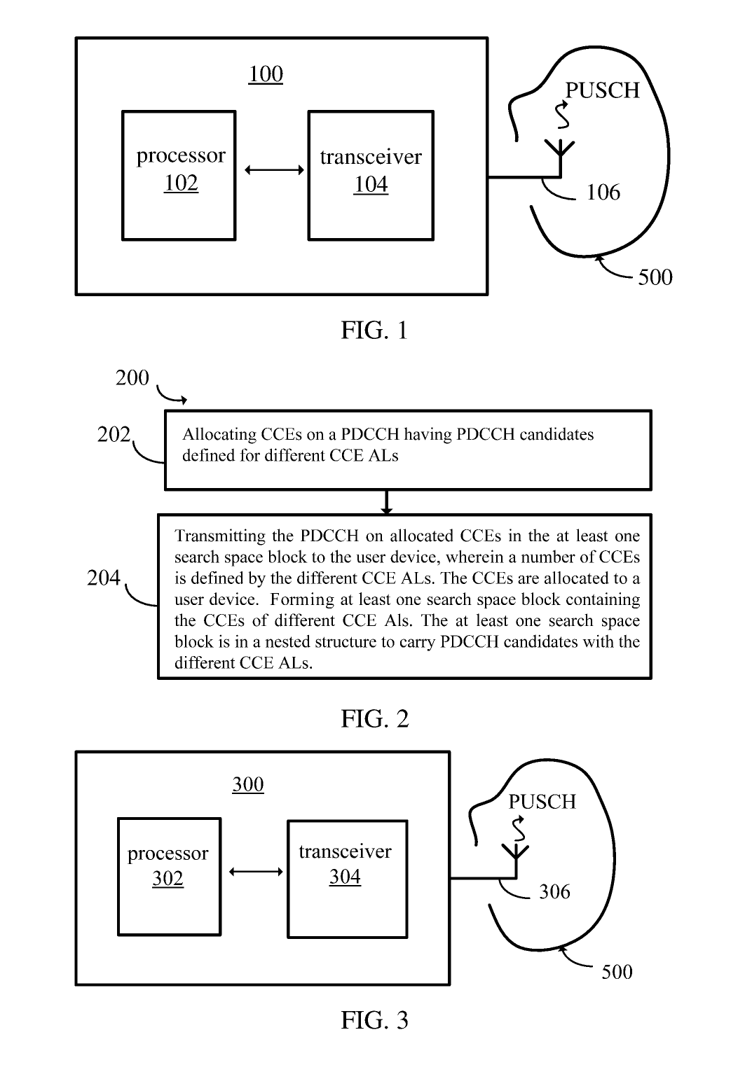

Referring to FIG. 1, a network node 100 is in communication with a wireless communication system 500. The network node 100 includes a processor 102 and a transceiver 104. The processor 102 is in communication with the transceiver 104. The network node 100 may include one or more optional antennas 106 coupled to the transceiver 104. The processor 102 is configured to allocate a plurality of control channel elements (CCEs) for a physical downlink control channel (PDCCH) having PDCCH candidates defined for a plurality of different CCE aggregation levels (ALs). A number of CCEs is defined by the different CCE ALs. The CCEs are allocated to a user device 300. The processor 102 is configured to form at least one search space block containing the CCEs of different CCE ALs, the at least one search space block is in a nested structure to carry PDCCH candidates with the different CCE ALs, and the processor 102 is configured to determine start positions of the at least one search space block, and the processor 102 is configured to determine locations of the PDCCH candidates of the different CCE ALs within the at least one search space block. The transceiver 104 is configured to transmit the PDCCH on allocated CCEs in the at least one search space block to the user device.

The network node 100 or base station, e.g. a radio base station (RBS), which in some networks may be referred to as transmitter such as eNB, eNodeB, NodeB, or B node, depending on the communication technology and terminology used. The radio network nodes may be of different classes such as e.g. macro eNodeB, home eNodeB or pico base station, based on transmission power and thereby also cell size. The radio network node can be a station (STA), which is any device that contains an IEEE 802.1 1-conformant media access control (MAC) and physical layer (PHY) interface to the wireless medium (WM).

Referring to FIG. 1 and FIG. 2, a method 200 may be executed in the network node 100. The method 200 includes a block 202 of allocating a plurality of control channel elements (CCEs) on a physical downlink control channel (PDCCH) having PDCCH candidates defined for a plurality of different CCE aggregation levels (ALs) and a block 204 of signaling allocation information to the user device 300. A number of CCEs is defined by the different CCE ALs. The CCEs are associated with a user device 300. The processor 102 is configured to group the CCEs in a search space into at least one search space block based on the different CCE ALs. The at least one search space block is in a nested structure to carry PDCCH candidates with the different CCE ALs, and the processor 102 is configured to determine start positions of the at least one search space block. The allocation information includes a frequency location and a number of the different CCE ALs.

The method further includes determining the start positions of the at least one search space block based on an output of a first hashing function using an identity of the user device 300. The method further includes shifting the start positions of the at least one search space block by an offset.

Referring to FIG. 3, the user device 300 includes a processor 302 and a transceiver 304. The processor 302 is in communication with the transceiver 304. In the embodiment, the user device 300 may further includes one or more optional antennas 306 coupled to the transceiver 304. The processor 302 of the user device 300 is configured to determine CCEs for at least one network nodes 100.

The transceiver is configured to transmit the CCEs for a physical downlink control channel (PDCCH) to the at least one network node 100. The CCEs are allocated for the PDCCH having PDCCH candidates defined for a plurality of different CCE aggregation levels (ALs). A number of CCEs is defined by the different CCE ALs. The CCEs are allocated to a user device 300. The processor 302 is configured to form at least one search space block containing the CCEs of different CCE ALs, the at least one search space block is in a nested structure to carry PDCCH candidates with the different CCE ALs, and the processor 302 is configured to determine start positions of the at least one search space block, and the processor 302 is configured to determine locations of the PDCCH candidates of the different CCE ALs within the at least one search space block.

The transceiver 304 is configured to transmit the PDCCH on allocated CCEs in the at least one search space block to the user device 300.

The user device 300 such as user equipment (UE), mobile station, wireless terminal and/or mobile terminal is in communication with the wireless communication system 500, sometimes also referred to as a cellular radio system. The user device 300 may further be referred to as mobile telephones, cellular telephones, computer tablets or laptops with wireless capability. The user device 300 may be, for example, portable, pocket-storable, hand-held, computer-comprised, or vehicle-mounted mobile devices, enabled to communicate voice and/or data, via the radio access network, with another entity, such as another receiver or a server. The user device 300 can be a STA, which is any device that contains an IEEE 802.1 1-conformant MAC and PHY interface to the WM.

In fourth generation of mobile phone mobile communication technology standards (4G) long term evolution (LTE) system, control region spans the whole system bandwidth and occupies first several orthogonal frequency-division multiplexing (OFDM) symbols in a subframe. Common reference signal (CRS) are used for demodulation of PDCCH. As CRS are shared by all the UE and locations of CRS are fixed in time-frequency domain, channel estimation can be accomplished once for all the PDCCH candidates by each UE when decoding its PDCCH in the control region.

In 5G new radio (NR) system, as demodulation reference signals (DMRS) is used for PDCCH demodulation and DMRS are transmitted along with target PDCCH for a particular UE (or a group of UEs), the UE could accomplish the channel estimation for decoding each PDCCH candidates. As the UE may have a number of PDCCH candidates with different control channel element (CCE) aggregation level (AL), and such candidates could be spread across the time-frequency resources in a control resource set (the time-frequency region that carry the control channel), the amount of channel estimation performance could be large if such performance could not be shared or reused among decoding different PDCCH candidates. To ease the issue, a nested structure could be utilized, where PDCCH candidates with different CCE AL could be aligned or confined in the same sets of resources.

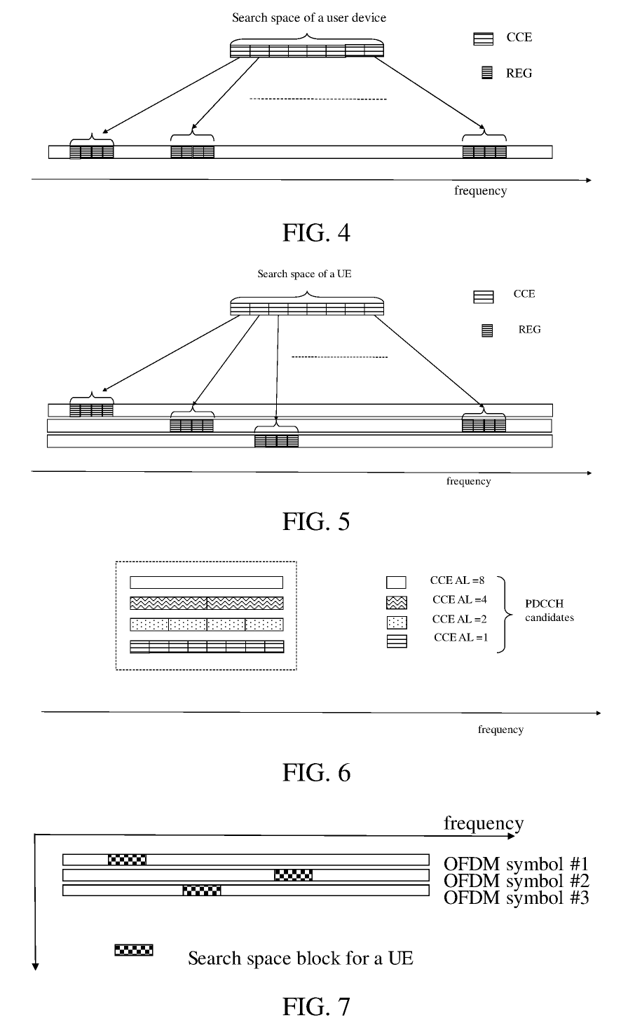

Referring to FIG. 4, an example where each CCE is mapped in a distributed manner to different frequency locations on the same OFDM symbol while the REGs in a CCE are mapped together. Such mapping has benefits, CCE is used as the smallest mapping unit, and therefore the REGs in a CCE (e.g., a CCE may contain 4 REGs as shown in the example) are allocated on contiguous resources, this could help with the channel estimation as more DMRS could be used. The distributed CCEs may benefits from frequency diversity gain.

The search space block could be a physical block, or the search space block could be a logical block. If the search space block is considered as logical block, components of the search space block could be further mapped to the physical resources in the control region. For example, the CCE or REG (a CCE further consists of multiple resource element group REG) in a search space block could be further mapped to different physical resource. FIG. 4 show an example where each CCE in a search space block are mapped in a distributed manner to different frequency locations on the same OFDM symbol while the REGs in a CCE are mapped together (namely they are mapped contiguously on frequency). Such mapping has benefits, a CCE is used as the smallest mapping unit, and therefore the REGs in a CCE (In the example shown a CCE is assumed to contain 4 REGs) are allocated on contiguous resources, this could help with the channel estimation as more DMRS could be used. The distributed CCEs may benefit from frequency diversity gain.

Referring to FIG. 5, to further exploit diversity gain in both time/frequency and allow power boosting, each CCE could be mapped to different OFDM symbols as an example. It should be mentioned that as examples, CCE AL=1, 2, 4, and 8 are used here. The proposal could be applied to other CCE AL as well.

Referring to FIG. 6, in an embodiment, PDCCH candidates with different AL (e.g., 1, 2, 4, and 8) all share (or partially shared) the same sets of resources. Benefits of such structure are that the channel estimation done on this set of resources could be reused by decoding all PDCCH candidates with different AL and thus save the overall channel estimation performance. Such structure also simplifies the search space definition of PDCCH. The search space is the combination of all PDCCH candidates that a UE may need to search for PDCCH. In LTE, the search space for PDCCH is defined on per CCE AL, namely, for each CCE AL, a separate search space is specified. In order to search for all its PDCCH candidates, the UE may need to search through all the search spaces for AL numbers 1, 2, 4, and 8 (that is AL=1, 2, 4, 8) and more. If nested structure is defined as mentioned here. The search space may not need to be specified based on CCE AL, but rather on a search space block level. For example, the PDCCH candidates with different CCE AL as shown in FIG. 6 could be specified as one search space block. UE could be configured with one or multiple search space blocks, each of search space blocks contains a combination of PDCCH candidates of different CCE AL. Such search space blocks could be distributed/contiguous on frequency/time and/or portions of the search space blocks could be distributed/contiguous on time/frequency through mapping of CCE-to-REG mapping. As the overall time-frequency control region is shared by all the UEs, and search space could have overlapping in time/frequency.

FIG. 7 is an example where a couple of search space blocks in a UE search space would be allocated on different OFDM symbols. This could allow the PDCCH candidates transmitted on different symbols. For example, if beamforming (BF) technique is used, and different OFDM symbol is associated with different analog beams, the transmission of PDCCH candidates on different OFDM symbols would allow them to be transmitted using different beams. This could be useful if one beam link pair (BLP, pair of gNB transmit and UE receive beams) fails as the gNB could use another beam to transmit PDCCH. It would also allow joint transmission of PDCCH on multiple beams, thus to improve the receiving quality of PDCCH especially for UEs in overlapping coverage of two transmit beams.

The nested structure has benefits as mentioned above, it may have an issue though. As the overall time-frequency control region is shared by all the UEs, and search space could have overlapping in time/frequency.

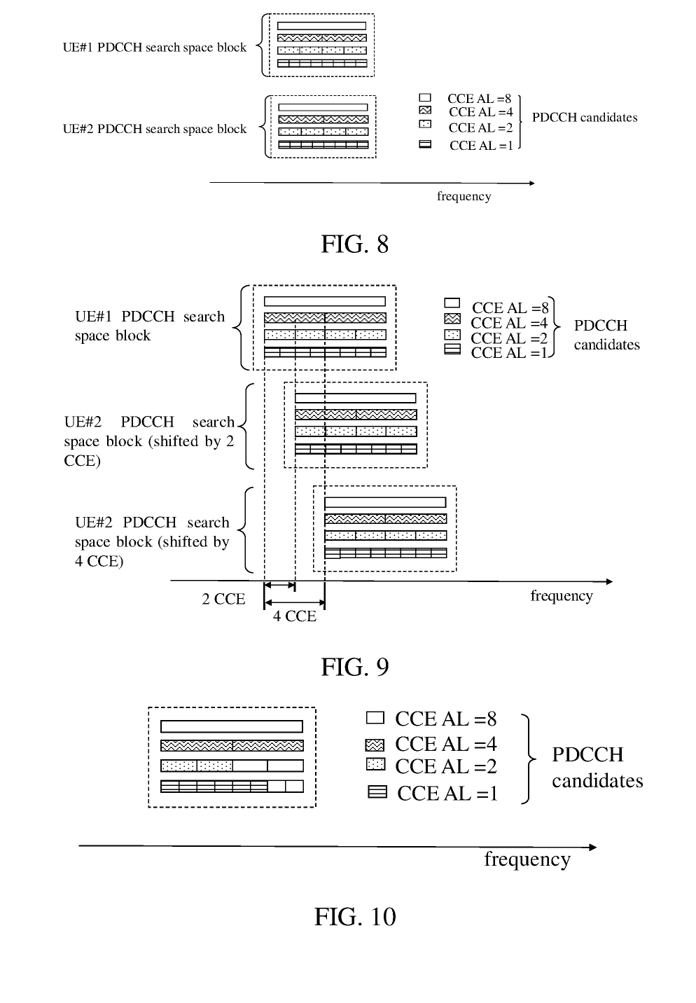

Referring to FIG. 8, if two UE's search spaces both have nested structure and search space blocks of the two UE's search spaces are completely overlapped, it may cause more blocking among the PDCCH candidates of the UEs. To solve this issue, a simply method is to add some offset among the starting CCE of the search space block.

Referring to FIG. 9, starting CCE index of nested search space block of a UE could be shifted by an offset of one or multiple CCE lengths, thus reduce the block issue but still maintain the nested structure of search space for each UE. The offset could be in the order of CCE(s). Such offset could be determined implicitly by some UE parameters such as UE RNTI, namely, it is a function of some UE identity such as RNTI, or it could be explicitly signaled by gNB, or it could be a combination of both.

In general, the overall resources that are available for a UE to search for its PDCCH could be grouped into a number of blocks, each contains the number of CCEs in largest CCE AL that is supported, say 8 or 16 CCEs. A Hashing function could be used in conjunction with maybe an offset (in the order of CCEs), to determine the start of a search space block for a UE. Here, a search space block of a UE is a set of CCEs that contain nested structure with PDCCH candidates of different CCE AL. As can be observed in FIG. 9, even though using an offset to shift the starting CCE position of search space blocks of different UE could reduce the blocking issue. It may not completely solve the issue as PDCCH candidates in lower CCE AL could still collide with each other. An alternative solution could be to select certain sets of resources in a search space block to transmit PDCCH candidates with lower CCE AL, and randomize such selections (CCE locations that are used to carry PDCCH candidates), thus lead less collisions among PDCCH candidates of different UEs.

As shown in FIG. 9 for an example, the starting CCE index of nested search space block of a UE could be shifted by an offset of one or multiple CCE lengths, thus reduce the block issue but still maintain the nested structure of search space for each UE. The offset could be in the order of CCE(s). Such offset could be determined implicitly by some UE parameters such as UE RNTI, namely, it is a function of some UE identity such as RNTI, or it could be explicitly signaled by gNB, or it could be a combination of both.

For example, it could be configured semi-statically using higher layer signaling such as RRC, it could also be transmitted in a group common control signal to a group UEs, alternatively, it could be signaled dynamically by physical layer signaling such as downlink control information (DCI). For example, if UE receives such an offset indication in a DCI, it may assume that its PDCCH search space needs to be shifted by such an offset from the next slot.

The offset values could be small or large, for example, the offset could be 1 CCE length, alternatively, it could be 4 CCEs length. There are pros and cons for small and large offsets. In general, the smaller the offset is, the higher blocking probability it could incur, and leads to less overall resource usage, while the larger the offset is, the less blocking probability it may incur, and may lead to more overall resource usage. The gNB could configure/signal different offsets for different scenarios. For example. If there are more UEs at cell center, which may more likely use 1 to 2 CCE ALs for PDCCH, it could configure small offsets and thus allow more search space overlapping but less overall resource usage (or with same amount of resources to support more UE). On the other hand, if there are more UEs at the cell edge, the gNB could configure larger offset which lead to less blocking issue especially for larger CCE AL. Such offset configuration could be cell specific or UE specific. In another embodiment, there are few UEs but all require higher CCE AL for its PDCCH, gNB could configure offsets such that all the search space block for each UE do not overlap with each other and therefore completely avoid the blocking issue.

Referring to FIG. 10 for an example, the PDCCH candidates for CCE AL=1 (that is a number of CCE AL is equal to 1) is configured to be 6 (instead of 8) and PDCCH candidates for CCE AL=1 is configured to be 2, thus maybe keep the total BD under a limit. The number of PDCCH candidates could be configured separately or together for each search space block assigned for a UE and signaled to the UE. A search space block (nested structure) could contain a full set of PDCCH candidates with different CCE AL as shown in FIG. 6, where the PDCCH candidates of each CCE AL is listed in Table 1. To control the total blind decoding (BD), the combination of PDCCH candidates could be adjusted and configured for each search space block by the gNB.

TABLE 1
Full set of PDCCH candidates in a nested search space block

| | CCE AL = 1 | CCE AL = 2 | CCE AL = 4 | CCE AL = 8 |
|---|---|---|---|---|
| PDCCH | 8 | 4 | 2 | 1 |
| candidates | | | | |

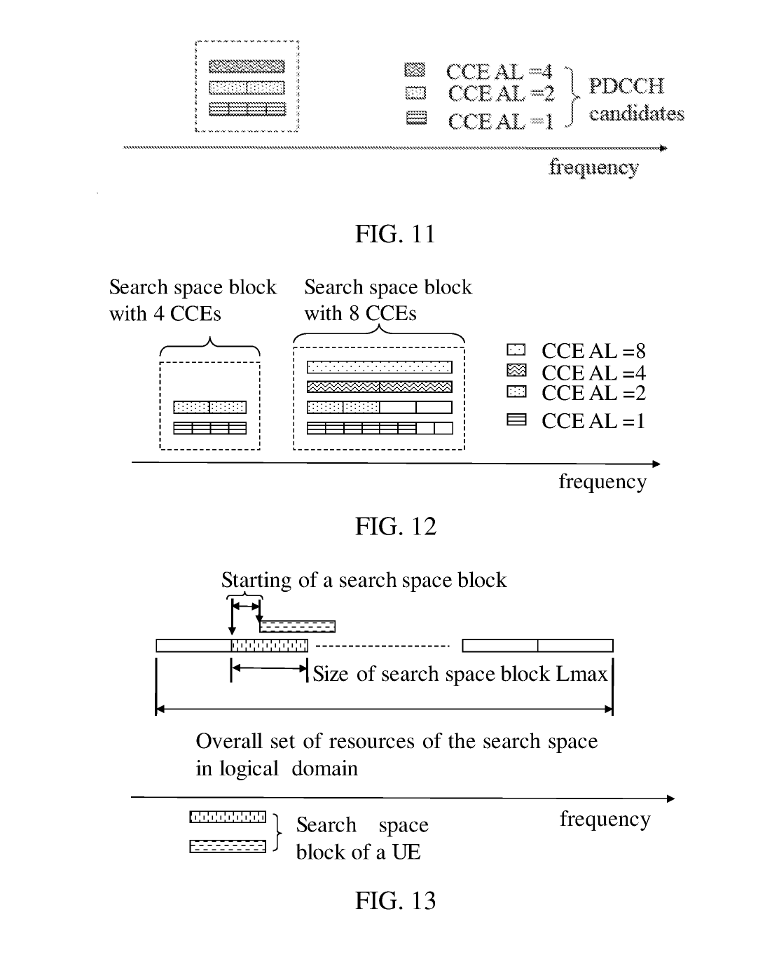

Referring to FIG. 11, an example of a search space lock with 8 CCEs is provided. In general, a search space block could be configured and signaled to the UE with different CCE length. The configuration could contain number of CCEs, the PDCCH candidates for each CCE AL etc. As shown in FIG. 11 as an example, a search space block has 4 CCEs and only support PDCCH candidates for CCE AL=1, 2 and 4. Such flexibility in search space block configuration will make the overall resource utilization more efficient, and yet maintain blocking probability in the control. For example, for the UE that is at cell center, the UE could be configured with search space blocks with less number of CCEs, while for UE at cell edge, search space blocks with larger number of CCEs could be configured.

Referring to FIG. 12, the configuration of search space block could be on per UE basis and even on per search space block basis, namely, each UE could be configured with different search space blocks with the same or different CCE numbers. For example, as shown in FIG. 12 as an example, for a particular UE in cell center, it could be configured with a couple of search space blocks, most of them with fewer number of CCEs (e.g., 4 or less). However, to maintain fall back mechanism, a search space block of 8 CCE could be configured. In the situation that channel is weak and unpredictable, the gNB could transmit PDCCH using 8 CCEs to maintain the robustness of the control link.

Referring to FIG. 13, in general, the overall resources that are available for a UE to search for PDCCH could be grouped into a number of blocks, each contains the number of CCEs in largest CCE AL that is supported, say 8 or 16 CCEs. A hashing function could be used in conjunction with maybe an offset (in the order of CCEs), to determine the start of a search space block for a UE. Here, a search space block of a UE is a set of CCEs that contain nested structure with PDCCH candidates of different CCE AL. FIG. 13 shows an example, in which an overall PDCCH search space could be divided into a number of search space block and each search space block contains Lmax CCEs where Lmax is the largest CCE AL that could be supported, for example Lmax=8 or 16. The starting CCE of a search space block for a UE could be determined by a hashing function based on UE identity (ID), slot number, and maybe plus an offset.

As can be observed in FIG. 9, even though using an offset to shift the starting CCE position of search space blocks of different UE could reduce the blocking issue. It may not completely solve the issue as PDCCH candidates in lower CCE AL could still collide with each other. An alternative solution could be to select certain sets of resources in a search space block to transmit PDCCH candidates with lower CCE AL, and randomize such selections (CCE locations that are used to carry PDCCH candidates), thus lead less collisions among PDCCH candidates of different UEs.

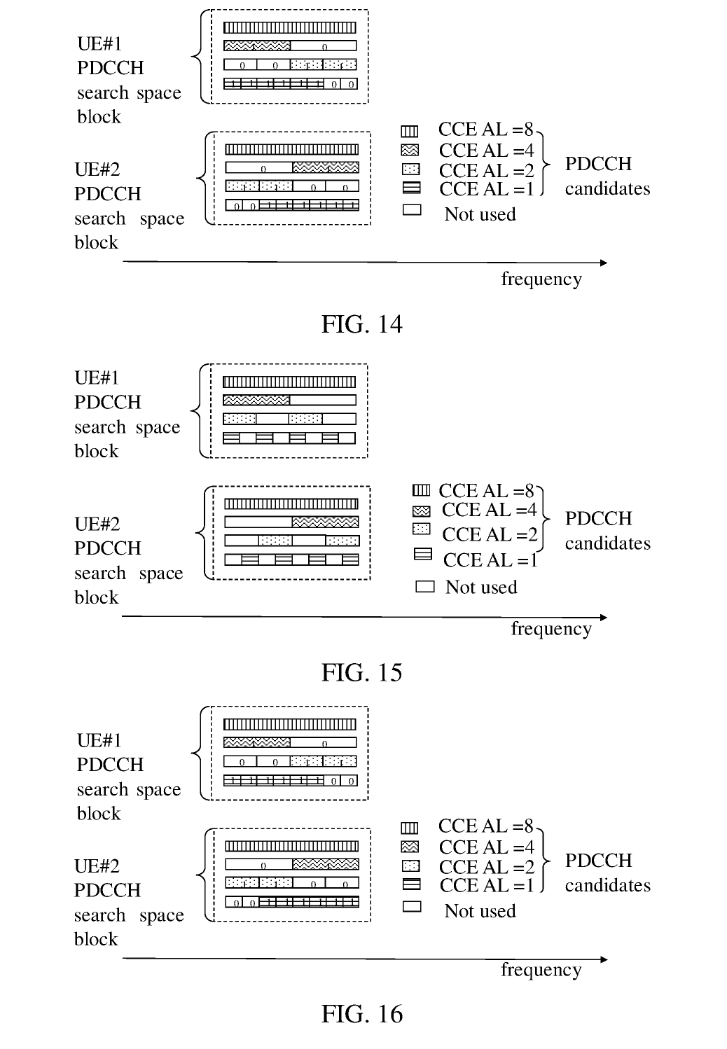

Referring to FIG. 14, an example, where only certain sets of resources in a search space block are used to transmit PDCCH candidates is provided. Such selection could be randomized between different UEs so that the collision opportunities of PDCCH respective candidates could be reduced.

Referring to FIG. 14, to randomize the selections, some alternative ways could be used. For example, different hashing functions bound by the search space block with a size of largest CCE AL supported could be used based on UE ID, slot/symbol index to determine locations of PDCCH candidates for each CCE AL within the search space block. To further reduce the chance of collisions, offsets could also be used to shift the PDCCH candidates. The following is an exemplary formula to indicate the start CCE of a PDCCH candidate with CCE AL=L.

$$L \{ ( {Y}_{k} + m ) mod ⌊ \frac{{N}_{CCE , {L}_{max}}}{L} ⌋ \} + {I}_{offset}$$

Where Yₖ is a variable that is based on UE ID and maybe some other parameters such as slot/symbol index. N_{(CCE, Lmax}) is the largest CCE AL that could be supported, e.g., 8 or 16. m is the PDCCH candidate index at CCE AL=L. I_{offset} is an offset which could be CCE AL dependent.

The resources (CCEs) selected to carry PDCCH candidates could be distributed in the search space block and thus reduce the chance of collisions. FIG. 15 shows such an example in which the CCEs that are allocated to carry PDCCH candidates are distributed in the search space block. The following exemplary formula could be used to calculate the start CCE of each PDCCH candidate at CCE AL=L. It shall be mentioned that the selection mentioned above are based on some implicit information such as UE ID, slot/symbol index, therefore, it may not need to be conveyed to the UE.

$$L \{ ( {Y}_{k} + 2 * m ) mod ⌊ \frac{{N}_{CCE , {L}_{max}}}{L} ⌋ \} + {I}_{offset}$$

Referring to FIG. 16, alternatively, an explicit bit-maps could be used to indicate the PDCCH candidates within a search space block. As shown in FIG. 16, for each sets of resources that could be used for a PDCCH candidate of a CCE AL, a bit could be used to indicate whether it is used to transmit a PDCCH candidate or not. Value “1” indicates a PDCCH candidate could be transmitted while value “0” indicates it is not used to transmit a PDCCH candidate. As such selection could be based on some explicitly indications such as using of bit-maps, it could be configured for the UE by higher layer signaling in a semi-static manner.

The explicit indications such as bit-map method could also be used to configure/indicate the number of PDCCH candidates for each CCE AL within a search space block as well as corresponding locations because the number of values “1” in bit-map corresponding to a CCE AL as described earlier indicates the number of PDCCH candidates for that CCE AL. Such configuration/indications could be the same for all search space blocks that are configured for the UE, or it could be search space block dependent, namely, for different search space blocks allocated for the UE, the configurations of PDCCH candidates within that search space block could be different. This could give gNB full flexibility in scheduling PDCCH transmission with necessary CCE AL, multiplexing different PDCCHs together and reducing the collisions.

The bit-map could also be used to indicate the search space blocks that are allocated to a UE as shown in FIG. 13 At the beginning, the UE can use Hashing function based on UE ID etc. to determine its search space blocks and upon receiving high layer signaling with a bit-map assignment, it could use that indication to determine its search space blocks.

The implicit and explicit ways of indicating PDCCH candidates could be used together. For example, start CCE of first PDCCH candidate of each CCE AL could be implicitly determined by UE ID, while explicit bit-map could be used to indicate following PDCCH candidates of the same CCE AL.

In the embodiment of the present disclosure, the processor is configured to group the CCEs in a search space into at least one search space block based on the different CCE ALs. The at least one search space block is in a nested structure to carry PDCCH candidates with the different CCE ALs. The processor is configured to determine start positions of the at least one search space block to balance between channel estimation performance.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure.

It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments.

Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A network node for a wireless communication system, comprising:
a processor configured to allocate a plurality of control channel elements (CCEs) for a physical downlink control channel (PDCCH) having PDCCH candidates defined for a plurality of different CCE aggregation levels (ALs), a number of CCEs being defined by the different CCE ALs, the CCEs being allocated to a user device, wherein the processor is configured to form at least one search space block containing the CCEs of different CCE ALs, the at least one search space block is in a nested structure to carry PDCCH candidates with the different CCE ALs; and
a transceiver configured to transmit the PDCCH on allocated CCEs in the at least one search space block to the user device.

2. The network node of claim 1, wherein the processor is configured to determine start positions of the at least one search space block, and the processor is configured to determine locations of the PDCCH candidates of the different CCE ALs within the at least one search space block.

3. The network node of claim 1, wherein the processor is configured to determine start positions of the PDCCH candidates within the at least one search space block based on at least one of an output of a first hashing function, a first offset, and a bit-map.

4-16. (canceled)

17. A user device for a wireless communication system, the user device comprising:
a processor configured to determine a plurality of control channel elements (CCEs) for at least one network node; and
a transceiver configured to transmit the CCEs in a physical downlink control channel (PDCCH) to the at least one network node, wherein the CCEs is allocated for the PDCCH having PDCCH candidates defined for a plurality of different CCE aggregation levels (ALs), a number of CCEs being defined by the different CCE ALs, the CCEs being allocated to a user device, wherein the processor is configured to form at least one search space block containing the CCEs of different CCE ALs, the at least one search space block is in a nested structure to carry PDCCH candidates with the different CCE ALs.

18. The user device of claim 17, wherein the processor is configured to determine start positions of the at least one search space block, and the processor is configured to determine locations of the PDCCH candidates of the different CCE ALs within the at least one search space block.

19. The user device of claim 17, wherein the processor is configured to determine start positions of the PDCCH candidates within the at least one search space block based on at least one of an output of a first hashing function, a first offset, and a bit-map.

20. The user device of claim 19, wherein the inputs of the first hashing function include at least one of the identity of the user device and a slot/symbol index.

21. The user device of claim 19, wherein the first hashing function is used in conjunction with a second offset.

22. The user device of claim 17, wherein the processor is configured to determine the start positions of the at least one search space block using at least one of an output of a second hashing function, a third offset, and a bit-map configuration to the user device.

23. The user device of claim 17, wherein the processor is configured to shift the start positions of the at least one search space block by an offset.

24. The user device of claim 17, wherein the search space blocks are located contiguously over time of a control region.

25. The user device of claim 17, wherein the search space blocks are located contiguously over frequency of a control region.

26. The user device of claim 17, wherein the search space blocks are distributed over time of a control region.

27. The user device of claim 17, wherein the search space blocks are distributed over frequency of a control region.

28. The user device of claim 17, wherein the search space blocks have different sizes.

29. The user device of claim 17, wherein a number of PDCCH candidates of each CCE AL in a search space blocks are configured.

30. The user device of claim 17, wherein the processor is configured to map the CCEs of the PDCCH candidates onto frequency in a distributed manner.

31. The user device of claim 17, wherein the processor is configured to map the CCEs of the PDCCH candidates onto time in a contiguous manner.

32. The user device of claim 17, wherein the CCEs comprise a plurality of resource element groups (REGs), wherein the CCE is a mapping unit of the PDCCH candidates, and the processor is configured to map the REGs on contiguous resources.

33. A method for a wireless communication system, the method comprising:
allocating a plurality of control channel elements (CCEs) for a physical downlink control channel (PDCCH) having PDCCH candidates defined for a plurality of different CCE aggregation levels (ALs), a number of CCEs being defined for the different CCE ALs, the CCEs being allocated to a user device, wherein the method further comprises forming at least one search space block containing the CCEs of different CCE ALs, the at least one search space block is in a nested structure to carry PDCCH candidates with the different CCE ALs; and
transmitting the PDCCH on allocated CCEs in the at least one search space block to the user device.

34-48. (canceled)
